(19) United States
(12) Patent Application Publication
(10) Pub. No.: US 2026/0326291 A1
(43) Pub. Date: Oct. 22, 2026

(54) SYSTEMS AND METHODS FOR CONTROLLING OBJECT MANIPULATORS

(71) Applicant: Walmart Apollo, LLC, Bentonville, AR (US)

(72) Inventors: Shane T. Shelbourn, Pea Ridge, AR (US); Nikhil Chinnalapatti Gopinath, Bengaluru (IN); Shashwat Chawla, Pittsburgh, PA (US)

(21) Appl. No.: 19/466,076

(22) Filed: Jan. 30, 2026

Related U.S. Application Data
(60) Provisional application No. 63/752,150, filed on Jan. 31, 2025.

(51) Int. Cl. B25J 9/16; G06V 20/50

(52) U.S. Cl. CPC B25J 9/163; G06V 20/50

(57) ABSTRACT

Embodiments relate to controlling hardware in a retail facility that includes a plurality of object manipulators, an image sensor, and a control circuit. The control circuit executes instructions to generate a context description using a large language model, and a confidence image and visual description using a visual language model based on the context description and an input image from the image sensor. The control circuit then generates a manipulation policy for an object manipulator using the large language model, based on the visual description and object manipulator type. The object manipulator performs a task on items according to machine instructions determined from the manipulation policy, confidence image, and object manipulator type.

### CROSS-REFERENCE TO RELATED APPLICATIONS

This application claims the benefit of U.S. Provisional Application No. 63/752,150 filed Jan. 31, 2025, which is incorporated herein by reference in its entirety.

### BACKGROUND

In various industrial, commercial, and logistics environments, there is a need to manipulate large numbers of objects, including loading and unloading objects that may be stacked, bundled, or otherwise arranged in bulk. Such environments may involve objects having different sizes, shapes, weights, and surface characteristics, and may present spatial constraints that complicate handling operations.

### BRIEF DESCRIPTION OF DRAWINGS

Various examples will be described below with reference to the following figures.

FIG. 1 is a block diagram of a system for controlling object manipulators in accordance with some embodiments.

FIG. 2 is a process diagram illustrating a process for generating object manipulation policies in accordance with some embodiments.

FIG. 3 is a block diagram illustrating a system in accordance with some embodiments.

FIG. 4 is a schematic diagram of an example facility environment including a plurality of types of object manipulators in accordance with some embodiments.

FIG. 5 is a block diagram illustrating a computing system in accordance with some embodiments.

FIG. 6 is a flow diagram illustrating a method for controlling hardware in a facility in accordance with some embodiments.

### DETAILED DESCRIPTION

Generally speaking, pursuant to various embodiments, systems, apparatuses, and methods are provided herein useful to control hardware in a retail facility. In some embodiments, a system includes: a plurality of types of object manipulators; an image sensor; and a control circuit to execute a set of computer executable instructions, which causes the control circuit to: generate, via a first model interface communicating with a large language model, a context description based on an input prompt; generate, via a second model interface communicating with a visual language model, a confidence image and a visual description based on the context description and an input image of a plurality of items captured by the image sensor; and generate, via a third model interface communicating with the large language model, a manipulation policy for an object manipulator of the plurality of types of object manipulators, wherein the manipulation policy is determined based on the visual description of the input; wherein the object manipulator is to perform an object manipulation task on the plurality of items based machine instructions determined based on the manipulation policy, the confidence image, and a type associated with the object manipulator.

In some aspects, there is a provided a method for controlling hardware in a retail facility, the method including: providing a plurality of types of object manipulators; providing an image sensor; executing a set of computer executable instructions to: generate, via a first model interface communicating with a large language model, a context description based on an input prompt; generate, via a second model interface communicating with a visual language model, a confidence image and a visual description based on the context description and an input image of a plurality of items captured by the image sensor; and generate, via a third model interface, a manipulation policy for an object manipulator of the plurality of types of object manipulators, wherein the manipulation policy is determined based on the visual description of the input image and a type associated with the object manipulator; wherein the object manipulator is configured to perform an object manipulation task on the plurality of items based machine instructions determined based on the manipulation policy, the confidence image, and a type associated with the object manipulator.

In some aspects, there is provided a non-transitory machine readable medium storing instructions that, when executed, cause a processing resource to: generate, via a first model interface communicating with a large language model, a context description based on an input prompt; generate, via a second model interface communicating with a visual language model, a confidence image and a visual description based on the context description and an input image of a plurality of items captured by an image sensor; and generate, via a third model interface, a manipulation policy for an object manipulator of a plurality of types of object manipulators, wherein the manipulation policy is determined based on the visual description of the input image and a type associated with the object manipulator; wherein the object manipulator is configured to perform an object manipulation task on the plurality of items based machine instructions determined based on the manipulation policy, the confidence image, and a type associated with the object manipulator.

The following description is not to be taken in a limiting sense but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in, but is not limited to, at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

In some aspects, and without limitation, the present disclosure relates to the handling of items (e.g., that vary in shape, density, weight, and material properties) by object manipulators. In some aspects, the systems and methods provided herein are hardware agnostic systems applicable to multiple types of hardware/object manipulators that utilize semantic reasoning to manipulate items. The present disclosure may enable manipulation techniques and optimize motion planning strategies, consequently increasing the accuracy of item retrieval and placement and minimizing the risk of item damage during manipulation. Generally, the systems and methods described herein utilize a combination of multiple hardware and software components to improve object manipulator control and performance. The systems and methods described herein may reduce damage to object manipulated by the system and increase the throughput of the system.

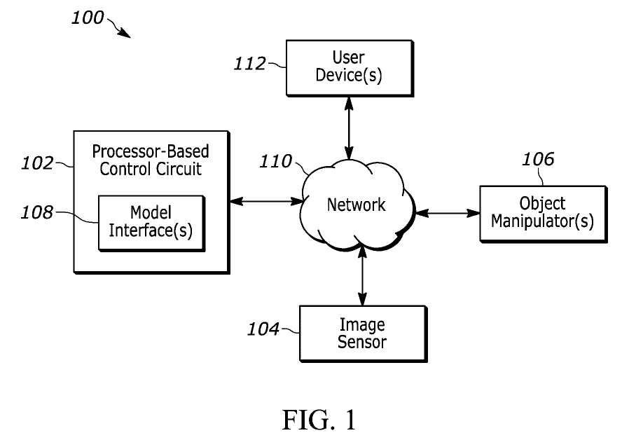

Referring to FIG. 1, a system 100 in accordance with some embodiments is shown. The system 100 generally includes a control circuit 102 (e.g., a processor, a hardware processing resource), an image sensor 104, at least one object manipulator 106, and/or user device(s) 112 communicatively coupled over a network 110. Generally, the system 100 is used to determine policies and parameters of object manipulator motion planning and may further control motion and task execution of object manipulators. In some aspects, the system 100 receives descriptive/textual commands from a user, indicating a desired action to be taken by the object manipulator(s) 106, and the control circuit 102 executing one or more model interfaces 108 uses the input to generate, via machine learning models, policies that are in turn used to determine instructions for the object manipulator(s) to perform the task. In one example, the system 100 is configured to cause a robotic arm mounted on a platform to pick irregular items from a stack and/or from a container such as a truck trailer. In another example, the system 100 is configured to identify fragile items and instruct the transport of the fragile items via a conveyor system in a manner that does not cause damage to the items. The system 100 may be hardware agnostic such that the policies generated by the model interface 108 can be used to determine instructions for multiple types of object manipulators 106. Generally, the system 100 utilizes machine learning models to provide semantic perception and context information to object manipulators for motion planning and controls.

The control circuit 102 is a processor-based control circuit. In some aspects, the control circuit 102 may include any suitable hardware processing resource configured to execute instructions stored in a computer-readable storage memory (e.g., a non-transitory, computer-readable storage medium). In this context, the terms control circuit and controller refer broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 102 or controller may be configured (for example, by using corresponding programming stored in a memory as will be well understood by those skilled in the art) to carry out one or more of the steps, actions, and/or functions described herein.

In some aspects, instructions executable by the control circuit 102 are stored in a computer readable storage memory. The computer readable storage memory may store any additional data relevant to the system 100 (e.g., item data, training data, historical inputs, historical manipulations policies, historical confidence images, historical context descriptions, historical visual descriptions, and the like). Examples of suitable computer readable storage memory includes random access memory (RAM), read-only memory (ROM), erasable programmable read-only memory (EPROM/flash memory), and so forth, and may include transient and/or non-transient mediums. The computer readable storage memory typically includes one or more processor-readable and/or computer-readable media accessed by at least the control circuit 102, and can include volatile and/or nonvolatile media, such as RAM, ROM, EEPROM, flash memory and/or other memory technology. The computer readable storage memory can be internal, external, or a combination of internal and external memory of the control circuit 102.

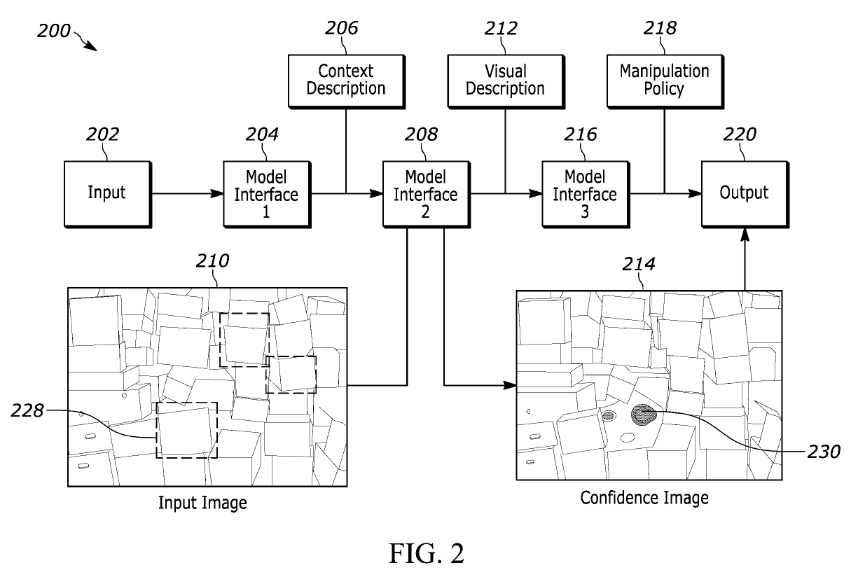

The control circuit 102 executes one or more model interfaces for determining object manipulation policies for the object manipulators 106. In some embodiments, the model interfaces may be an application programming interface (API) or other software module that is configured to generate one or more prompts to a machine learning module (e.g., a large language model (LLM), a visual language model (VLM), and the like). The prompts may be pre-programed, determined based on templates, and/or dynamically generated. The functions of the model interfaces 108 are described in further detail with reference to FIGS. 2, 3, 5, and 6, herein.

In some embodiments, the model interfaces may include agents (e.g., LLM agents) to execute the functions described herein. For example, the model interfaces 108 may be systems built on top of a machine learning model (e.g., a LLM, VLM) that may interact with external tools and application programming interfaces (APIs). A machine learning agent may further maintain a state and/or context across multiple steps by calling a machine learning model multiple times and recalling the input(s) and/or output(s) of each call. In some aspects, a machine learning agent may autonomously work toward specific goals (e.g., by planning a series of steps and delegating the steps to additional machine learning models). In other words, a machine learning agent utilizes machine learning models along with additional tools (e.g., open-source resources, search engines, additional models, etc.) in order to complete tasks.

In some aspects, the control circuit 102 may access and/or execute various additional applications, software models, and/or hardware components (which may be internal and/or external to the system 100) to perform the processes described herein. For example, the control circuit 102 and components accessible to the control circuit 102 may monitor safety within system 100, manage components of system 100 (e.g., the object manipulators 106), generate instructions to the object manipulators 106, and so forth. In some aspects, the control circuit 102 is in communication with a task management system that sends instructions and/or monitors the operations of the object manipulators 106.

The image sensor 104 generally refer to sensors capable of capturing 2D and/or 3D images (e.g., a camera, optical sensors, etc.). In some embodiments, the image sensor 104 may be stationary (e.g., fixed), mobile (e.g., moveably mounted, motorized, etc.), have any suitable frame of reference (e.g., fixed and/or variable), have any suitable image type (e.g., 2 dimensional, 3, dimensional, etc.), and so forth. In some aspects, images are captured continuously, periodically (e.g., every 5 minutes, every hour, etc.), and/or in a response to an event (e.g., the receival of input from a user, an indication to capture an image, and the like). In some embodiments, the image sensors 104 may be integrated with and/or mounted on one or more object manipulators 106. In some instances, images captured by image sensors 104 on one type of object manipulator (e.g., mobile robot) may be used to generate policies for other types of object manipulators (e.g., conveyor belts). Generally, the images captured by the image sensor 104 are utilized by the control circuit 102 and/or model interfaces 108 as input image to perform the processes described herein.

An object manipulator 106 generally refers to a hardware apparatus configured to physically manipulate the position, orientation, and/or location of objects according a set of machine instructions. An object manipulator 106 may be robotic and/or motorized. Further referring to FIG. 4, a system 400 (which may be the same as the system 100 and/or include components of the system 100) shows a retail facility 402 including an image sensor 104 and a plurality of types of object manipulators 106. Examples of suitable object manipulators 106 include, but are not limited to, conveyor systems 410, robotic arms 406, mobile manipulators 408, humanoid manipulators 404, and the like as illustrated in FIG. 4. As further examples, the object manipulator 106 may include articulating industrial arm variants (such as collaborative robots), process-oriented assemblies of system components (e.g., hard-automation), bi-pedal or ‘humanoid’ robots, quadruped robots, various wheeled, tracked, or ariel systems, and/or parallel link robots. In some embodiments, a model interface 108 is used to generate manipulation policies which is used to determine instructions for the object manipulator 106. The generated policy may be manipulator agnostic, meaning that the same set of policies may be used to plan the motion of and/or translated into machine instructions for the control of a plurality of types of object manipulators. In some embodiments, the same policies may be used by multiple object manipulators of the same or different types that transport the object from an origin location to a destination location.

In some aspects, the object manipulators 106 are cooperated with additional sensors which include, but are not limited to, cameras, microphones, RGB-D sensors, LiDAR sensors, line-scanning lasers. The additional sensors may be incorporated into a respective object manipulator 106 and/or may be remotely mounted relative to the object manipulator 106 to scan an operating environment. The described sensors may be used to establish an item’s spatial information (e.g., during manipulation) required during automated motion planning and/or ancillary tasks performed by the system 100 and/or components communicated with the system 100.

Referring back to FIG. 1, the user devices 112 include a processor-based device operatively coupled to the any described components of the system 100 and may include, but are not limited to, smartphones, tablets, laptops, computers, and/or other such computing systems that enable a user to communicate with the system 100. In some aspects, one or more user devices 112 may be part of the system 100 and/or one or more user devices 112 may be separate and distinct from the system 100. The system 100 can further include and/or be in communication with one or more networks 110. The user device(s) 112 can allow a user to interact with the system 100 and receive information through the system 100. In some instances, the user device 112 includes a display and/or one or more user inputs, such as buttons, touch screen, trackball, keyboard, mouse, etc., which can be part of or wired or wirelessly coupled with the system 100. In some aspects, the user device(s) 112 is a mobile device.

The network 110 may be any suitable network or communication method such as, for example, a local area network (LAN), the Internet, wide area network (WAN), etc., communication link, other networks or communication channels with other devices and/or other such communications (not shown) or combination of two or more of such communication methods. There may be any combination of wired connections and/or wireless connections (e.g., Wi-Fi, Bluetooth, cellular, RF, and/or other such wireless communication) between elements of the system 100.

Referring to FIG. 2, a process 200 is shown in accordance with some embodiments. In some embodiments, the process 200 may be executed by the control circuit 102 described with reference to FIG. 1 above.

The process is initiated by an input prompt 202. The input prompt 202 may be one or more a textual input, an audio input, and/or additional modalities of input from a user (e.g., via the user device(s) 112). For example, the input may be a user typing into a keypad or speaking into a microphone, a task command (e.g. “pick irregular boxes,” “pick non-box object”). While user input is generally described herein, in some embodiments, the input may be recorded and/or programmed inputs from a software module and/or control circuit. The input is received at a first model interface 204.

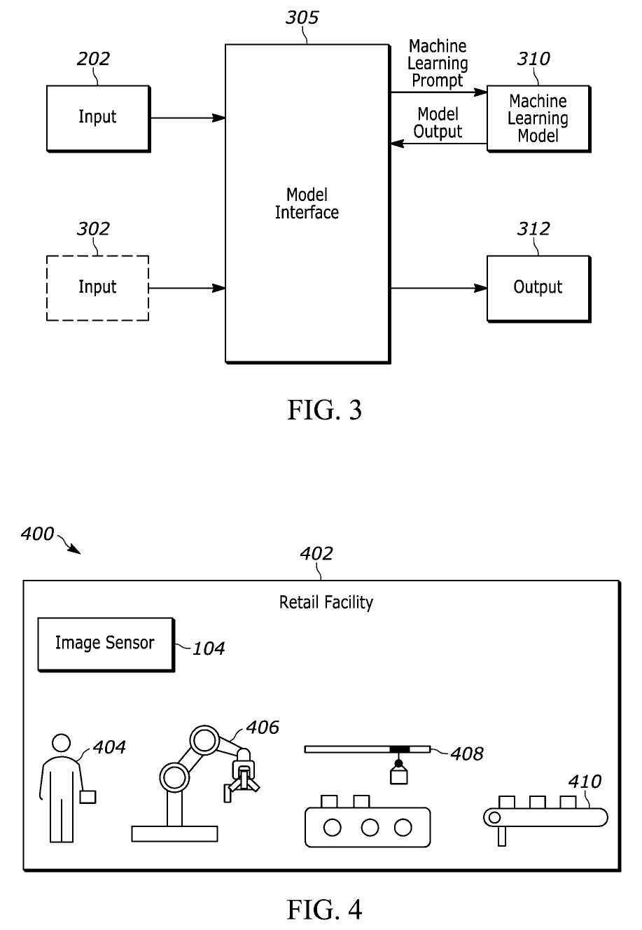

Further referring to FIG. 3, a block diagram illustrating a model interface 305 Is shown. The model interface may be the first model interface 204, the second model interface 208, and/or the third model interface 216. Generally, a model interface 305 is a software module that is configured receives one or more inputs, such as inputs 202 and 302, and generates a machine learning model prompt or a series of prompts to a machine-learning model 310 to obtain the model output. The prompt may be generated based on programmed logic and/or templates and the input. In some embodiments, the model interface may further access other data sources (e.g., databases, external services) to determine and generate the prompt. In some embodiments, the model interface 305 may be a machine learning model agent configured to autonomously determine and/or send prompts a machine learning model in a series of steps. The model interface 305 may further generate an output 312 based on the model output. For example, the model output may be normalized to a set of predefined descriptors prior to outputting the description. For example, the descriptions from the model may be matched to the closest description in the predefined set of descriptors. It is generally contemplated that any number of inputs 202, 302 may be received and combined by a model interface 216 to generate the machine learning model prompt output 312.

Referring back to FIG. 2, the first model interface 204 interfaces with an LLM in accordance with some embodiments. The first model interface 204 receives the input prompt 202 indicating a task to be performed by one or more object manipulators. The first model interface 204 is configured to generate a prompt for an LLM based on the input to cause the LLM to generate a context description 206 associated with the input. In some embodiments, the input prompt 202 may be in natural language, and the first model interface 204 may use a natural language processing (NLP) model to generate a prompt to the LLM. In some embodiments, the input may be in natural language, and the first model interface 204 may use a speech recognition algorithm to generate a prompt to the LLM.

Generally, a context description 206 is a textual description which further defines a task indicated in the input prompt. For example, an input “pick irregular boxes” may generate a context description 206 of “find boxes with lid opened, asymmetric, uneven.” In other words, the context description 206 provides further/expanded descriptions of the indicated task and provides criteria and context for the subsequent model interfaces. In some aspects, the first model interface 204 may determine that the input prompt 202 is not sufficient to generate a context description 206 and may, for example, output a notification to a user device 112 indicating that additional input is required. For example, the LLM may return the response to the prompt with a confidence score. In the event that the confidence score is below a predetermined threshold (e.g., 80%), the first model interface 204 may be configured to alert the user for alternative or additional input.

The second model interface 208 receives the context description 206 from the first model interface 204 and an input image 210 (e.g., captured by the image sensor 104). Generally, the input image 210 depicts a plurality of items 228 located in an area of interest (e.g., within the retail facility 402, in a trailer, etc.). The image may include a group of objects, such as a stack of objects and/or a pallet of objects on which the task indicated in the input prompt 202 is to be performed.

The second model interface 208 interfaces with a VLM in accordance with some embodiments. The second model interface 208 provides the input image 210 along with a prompt generated based on the context description 206 to a VLM to generate a confidence image 214 and a visual description 212 of the input image. In some aspects, the VLM provides detailed object information including material, type, fragility, and/or other characteristics and outputs the information in multimodal formats (e.g., the visual description 212, the confidence image 214, an audio output, and so forth). Generally, the visual description 212 is a textual description of one or more areas within the input image 210. For example, the visual description 212 may label the items 228 in the input image 210 (e.g., box 1, box 2, box 3, etc.) and indicate which items 228 fulfill the criteria indicated in the context description 206. For example, the described input prompt 202 of “pick irregular boxes” may generate a visual description 212 of “box 1- lid opened, boxes 2 and 3- irregular.” In some aspects, each item 228 labeled in the visual description 212 may be associated with a coordinate location on the input image 210 (e.g., indicating which box is which and associating an item 228 with a location).

In some aspects, the confidence image 214 includes a version of the input image 210 with an indicator 230 indicating which items (of the items 228 in the input image 210) are associated with task instruction of the input prompt 202. In some aspects, the indicator 230 includes a heat map (as shown) and/or coordinates indicating the location of items 228 associated with the input prompt 202. In some aspects, the confidence image 214 is used to translate a frame of reference of the image sensor 104 (including a corresponding image sensor 104 coordinate system) into a frame of reference of a respective object manipulator 106 (including a corresponding object manipulator 106 coordinate system) such that an object manipulator 106 is able to locate and orient itself relative to the items 228 indicated. In some aspects, the confidence image 214 is a mask (e.g., isolating specific portions of the input image 210, such as the indicator 230) overlayed on the input image 210.

The third model interface 216 interfaces with a LLM in accordance with some embodiments. The third model interface 216 receives the visual description 212 from the second model interface 208. The third model interface 216 is configured to provide a prompt to a LLM based on the visual description to generate manipulation policies. The third model interface 216 may utilize the same or different LLM as the first model interface 204. The LLM may determine a precise gripping location on an item 228, relevant parameters (e.g., the limitations described herein), which may influence object handling and/or other manipulation strategies through the manipulation policy 218. In some aspects, a manipulation policy 218 includes limitations (e.g., of an object manipulator 106 relative to the items 228) which include pressure (e.g., exerted by an object manipulator 106 on an item 228, a force (e.g., experienced by the items 228), a tool (e.g., an end effector, a gripping device, a suction device, pneumatic pressure devices, hydraulic devices, motorized mechanism, manual operation, etc., utilizing autonomous operation, semi-autonomous operation, and/or manual operation), a position (e.g., a pose of the item 228 prior to the object manipulation task and/or after the object manipulation task), a speed (e.g., of movement of the items 228 during the object manipulation task), an orientation (e.g., upwards, sideways, upside down orientation of an item 228 before, during, and/or after the object manipulation task), a trajectory (e.g., rotation of the item 228, path taken of the item 228 during the object manipulation task, collision avoidance of the 228 and/or the object manipulator 106 with other components, etc.), and so forth. For example, an input prompt 202 of “pick irregular items” may generate a manipulation policy 218 of “pick box 1 from the top, minimal rotation for no spillage”. In some embodiments, the third model interface 216 may normalize the output of the LLM by, for example, matching the output of the LLM to one of a set of predefined grasping policies before outputting the grasping policies for use by the object manipulators.

In some aspects, the manipulation policies 218 and the confidence image 214 are provided as output 220 to a task manager for use in determining a set of control parameters and/or machine instructions for execution by the object manipulators 106.

The task manager may include a motion planner that plans manipulator motion based on goals and constraints, such as the locations within the confidence map, capabilities of the object manipulators, and limitations/requirements in the manipulation policies. In some embodiments, the task manager may access a table corresponding manipulation policy to object manipulator control parameters to determine the machine control instructions of the object manipulator 106 for task execution. In some embodiments, the manipulation policies may be used to determine movement limitations (e.g., angle, speed, position, etc.) when the task manager plans out the movement path/pattern of the object manipulator.

In some embodiments, the manipulation policies 218 is not specific to a particular object manipulator 106 and may be used in generating control instructions to any number of types of object manipulator 106. For example, the same set of manipulation policies 218 may be used to determine the grip strength of a robotic arm and the speed of a conveyor belt for transporting the same item. In some embodiments, the task manager may use different subsets of manipulation policies for different types of object manipulators. The process shown in FIG. 2 may be executed once for an object, and the stored manipulation policies for the object may be reused as the object is moved from an origin location (e.g., trailer) to a destination location (e.g., storage shelf) by a plurality of object manipulators with transfers between the object manipulators and/or human operators. That is, by configuring the process to output a standard/agnostic set of manipulation policies that can be used by different types of object manipulators, the computation cost of utilizing LLM-based semantic perception for object manipulation control can be significantly reduced.

In some embodiments, failure to generate a manipulation policy 218 causes the control circuit 102 to output a notification for display on a user device 112 which indicates the failure. In some aspects, the notification indicates why a manipulation policy was unable to be generated (e.g., a specific limitation was unable to be determined, not enough information was provided, etc.), and in some aspects may indicate how a user may remedy the error (e.g., capture a new input image 210, alter the input prompt 202 and so forth).

In some aspects, the model interfaces 204, 208, and 216 may be dynamic model agents that may be trained or adjusted with feedback data. For example, a successful performance of an object manipulation task by an object manipulator 106 causes the control circuit 102 to update at least one of the first model interface 204, the second model interface 208, or the third model interface 216. For example, each model interface may have a set of prompts it can use to prompt the LLM or VLM, and through feedback, the model interfaces may select from among the set of prompts and/or modify the prompts for subsequent processes.

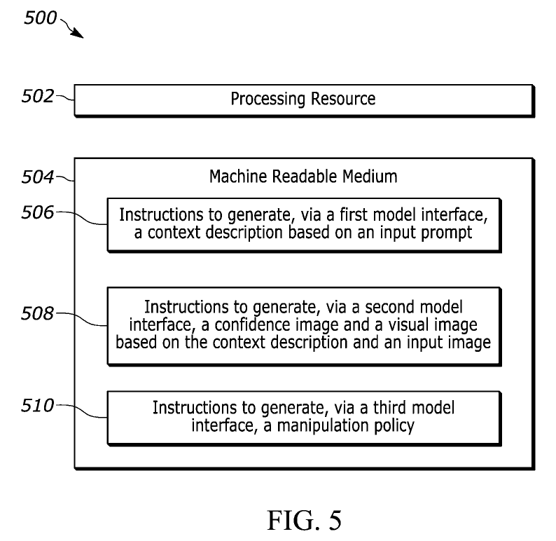

Referring to FIG. 5, a system 500 is shown in accordance with some embodiments. The system 500 may, in some embodiments, be the processor-based control circuit 102 described with reference to FIG. 1 or a similar device. The system 500 generally includes a non-transitory machine readable medium 504 programmed with computer executable instructions (e.g., the instructions 506, 508, 510) for operating a computing device including a processing resource 502. The instructions 506, 508, 510 are executable by the processing resource 502 and that, when executed, cause the processing resource 502 to perform various actions and/or steps.

When executed, the instructions 506 cause the processing resource 502 to generate, via a first model interface communicating with a LLM, a context description based on an input prompt. When executed, the instructions 508 cause the processing resource 502 to generate, via a second model interface communicating with a visual language model, a confidence image and a visual description based on the context description and an input image of a plurality of items captured by an image sensor. When executed, the instructions 510 cause the processing resource 502 to generate, via a third model interface, manipulation policies for an object manipulator of a plurality of types of object manipulators based on the visual description of the input image and a type associated with the object manipulator. The manipulation policies may be used by one or more task managers, executed by the processing resource 502 or a separately implemented processing resource, to determine machine control instructions for a plurality of types of object manipulators.

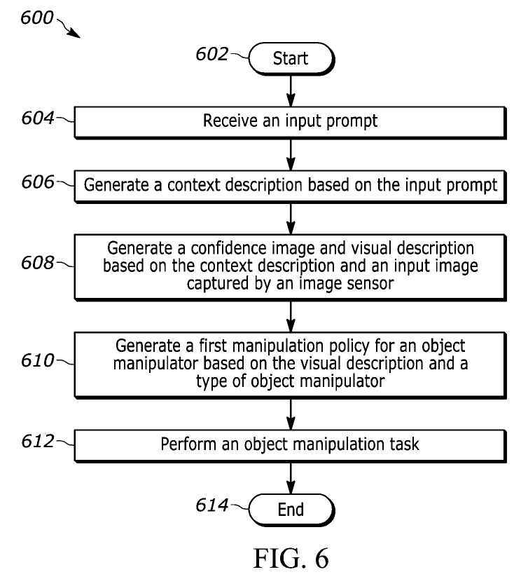

FIG. 6 shows a method 600 of controlling hardware in a retail facility in accordance with some embodiments. In some embodiments, the method 600 may be implemented by the systems 100 and/or components thereof as described herein. Generally, the method 600 begins at a starting point 602. At a step 604, an input prompt is received (e.g., from a user via a user device), the input prompt indicating a desired object manipulation task to be performed by an object manipulator on a plurality of items. In some embodiments, multiple inputs are received, and the method 600 further includes aggregating each of the inputs to determine the prompt for the LLM.

At step 606, a first model interface communicates with a LLM to generate a context description associated with the input prompt. The context description generally is a contextual description of the input prompt to be used by further model interfaces. For example, the context description may expand and further describe the object characteristics in the task description of the input. At step 608, a second model interface communicating with a visual language model generates a confidence image and a visual description based on the context description and an input image of a plurality of items captured by an image sensor. The visual description is generally a textual description of the input image and items therein, in the context of the task described in the input prompt. The confidence image is a version of the input image including an indicator indicating items of the plurality of items associated with textual description and/or the context description. For example, the confidence image may indicate likely locations of opened boxes within the image.

At step 610, a third model interface generates a manipulation policy for an object manipulator of a plurality of types of object manipulators based on the visual description of the input image and a type associated with the object manipulator. In some aspects, the manipulation policy includes limitations of a pressure, a force, a tool, a position, a speed, an orientation, a trajectory, etc., for an object manipulator to execute during an object manipulation task. At step 612, the object manipulator performs the object manipulation task on the plurality of items according to machine instructions determined based on the manipulation policy, the confidence image, and the type of the object manipulator. In some aspects, the manipulation policy is translated into a set of machine instructions executable by the object manipulator. The translator may be a motion planner that’s plans manipulator motion based on goals and constraints, such as the locations within the confidence map, capabilities of the object manipulators, and limitations/requirements in the manipulation policies. The method 600 is completed at the end point 614.

In embodiment of the systems and method described herein, incorporates machine learning model and semantic reasoning to provide robotic object manipulators with context during relevant tasks. This improves the decision-making process and enhances the overall performance of the system. combining multiple machine learning models and hardware components to create a more efficient, accurate, and flexible system for controlling object manipulators in a retail environment.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system for controlling hardware in a retail facility, the system comprising:
a plurality of types of object manipulators;
an image sensor; and
a control circuit to execute a set of computer executable instructions, which causes the control circuit to:
generate, via a first model interface communicating with a large language model, a context description based on an input prompt;
generate, via a second model interface communicating with a visual language model, a confidence image and a visual description based on the context description and an input image of a plurality of items captured by the image sensor; and
generate, via a third model interface communicating with the large language model, a manipulation policy for an object manipulator of the plurality of types of object manipulators, wherein the manipulation policy is determined based on the visual description of the input image and a type associated with the object manipulator;
wherein the object manipulator performs an object manipulation task on the plurality of items according to machine instructions determined based on the manipulation policy, the confidence image, and a type associated with the object manipulator.

2. The system of claim 1, wherein the control circuit further:
wherein a second object manipulator of a second type is configured to perform a second object manipulation task on the plurality of items based on the manipulation policy and the confidence image.

3. The system of claim 1, wherein the plurality of types of object manipulators includes at least two of a conveyor system, a robotic arm, a mobile manipulator, or a humanoid manipulator.

4. The system of claim 1, wherein the control circuit further:
receives an input comprising a textual input or an audio input; and
generates the input prompt based on the input.

5. The system of claim 4, wherein the first model interface generates the input prompt based on the audio input.

6. The system of claim 1, wherein the control circuit further:
receives two or more inputs; and
aggregates each of the two or more inputs into the input prompt.

7. The system of claim 1, wherein the confidence image comprises a version of the input image with an indicator indicating items of the plurality of items associated with the input prompt, wherein the indicator includes a heat map or coordinates.

8. The system of claim 1, wherein the manipulation policy includes limitations of at least one of a pressure, a force, a tool, a position, a speed, an orientation, or a trajectory for the object manipulation task to be executed by the object manipulator.

9. The system of claim 1, wherein failure to generate the manipulation policy causes the control circuit to output a notification for display on a user device.

10. The system of claim 1, wherein the control circuit further:
updates at least one of the first model interface, the second model interface, or the third model interface based on a successful performance of the object manipulation task.

11. The system of claim 1, wherein the manipulation policy is translated into a set of machine instructions for execution by the object manipulator.

12. A method for controlling hardware in a retail facility comprising:
providing a plurality of types of object manipulators;
providing an image sensor; and
executing a set of computer executable instructions to:
generate, via a first model interface communicating with a large language model, a context description based on an input prompt;
generate, via a second model interface communicating with a visual language model, a confidence image and a visual description based on the context description and an input image of a plurality of items captured by the image sensor; and
generate, via a third model interface, a manipulation policy for an object manipulator of the plurality of types of object manipulators, wherein the manipulation policy is determined based on the visual description of the input image and a type associated with the object manipulator;
wherein the object manipulator is configured to perform an object manipulation task on the plurality of items according to machine instructions determined based on the manipulation policy, the confidence image, and a type associated with the object manipulator.

13. The method of claim 12, the method further comprising:
receiving an input comprising a textual input or an audio input; and
generating the input prompt based on the input.

14. The method of claim 13, wherein the first model interface generates the input prompt based on the audio input.

15. The method of claim 12, the method further comprising:
receiving two or more inputs; and
aggregating each of the two or more inputs into the input prompt.

16. The method of claim 12, the method further comprising:
outputting a notification for display on a user device in response to a failure to generate the manipulation policy.

17. The method of claim 12, the method further comprising:
updating at least one of the first model interface, the second model interface, or the third model interface based on a successful performance of the object manipulation task.

18. The method of claim 12, the method further comprising:
translating the manipulation policy into a set of machine instructions for execution by the object manipulator.

19. The method of claim 12, wherein the manipulation policy includes limitations of at least one of a pressure, a force, a tool, a position, a speed, an orientation, or a trajectory for the object manipulation task to be executed by the object manipulator.

20. A non-transitory machine readable medium storing instructions that, when executed, cause a processing resource to:
generate, via a first model interface communicating with a large language model, a context description based on an input prompt;
generate, via a second model interface communicating with a visual language model, a confidence image and a visual description based on the context description and an input image of a plurality of items captured by an image sensor; and
generate, via a third model interface, a manipulation policy for an object manipulator of a plurality of types of object manipulators, wherein the manipulation policy is determined based on the visual description of the input image and a type associated with the object manipulator;
wherein the object manipulator is configured to perform an object manipulation task on the plurality of items according to machine instructions determined based on the manipulation policy, the confidence image, and a type associated with the object manipulator.
